(19) United States
(12) Patent Application Publication
(10) Pub. No.: US 2009/0171667 A1
(43) Pub. Date: Jul. 2, 2009

(54) SYSTEMS AND METHODS FOR LANGUAGE ASSISTED PATIENT INTAKE

(76) Inventor: Carmen Hansen Rivera, Indianapolis, IN (US)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 11/966,583

(22) Filed: Dec. 28, 2007

(51) Int. Cl. G10L 11/00

(52) U.S. Cl. 704/275; 704/276; 704/E15.04

(57) ABSTRACT

A method for assisting in the communication of a medical care provider and a patient is disclosed. The method may include displaying a first display section, the first display section including a plurality of anatomical features, each anatomical feature associated with an indicia indicating the location of the anatomical feature, the anatomical feature also associated with a first name provided in a first language and a second name provided in a second language name. The method may also include displaying a second display section, the second display section including a plurality of questions relating to patient intake, where each question provided in the first language and the second language.

### BACKGROUND

1. Technical Field

This application relates to language assistance systems. More particularly, this application relates to a flexible system for providing language assistance during a medical procedure, such as patient intake.

2. Related Art

Communication problems during medical procedures, such as during a medical emergency, can lead to many problems. For example, medical professionals, such as doctors, nurses, and the like, determine that a particular treatment or medication is appropriate for a particular patient based on the information the patient gives the doctor. If a patient complains of a particular type of pain, the doctor may prescribe a pain medication. However, if the patient misunderstands the question, or the doctor misunderstands the answer, the doctor may determine that a different medication should be used, which may exasperate the situation. Moreover, certain medical emergencies, such as life threatening conditions and the like, may be missed if the medical professional is unable to obtain accurate information from the patient. As a result, many unnecessary health complications and/or deaths may occur.

Communication problems may occur when the medical professional and patient speak different languages. Although certain symptoms can be detected through physical examination alone, other symptoms can only be communicated, either orally or written, by the patient. This may includes answering questions about their condition and the like. The more accurate diagnosis obtained via a full communication path between doctor and patient is impossible to obtain if there is a language barrier between the two. Even if the medical professional has some language proficiency in the patient's native tongue, the limited proficiency may cause additional communications problems, such as those caused by slang and dialect issues.

In order to alleviate the problems associated with language barriers, translators have been used. While a translator fluent in languages that both the doctor and patient can provide a broad range of communication between the two, it may be difficult to obtain the services of such a person in time to identify medical emergencies. For example, on average it may take approximately 30-45 minutes for a translator to arrive at a given medical facility in response to a request for language assistance services. It may take up to 5 hours. Additionally, that time can increase dramatically for obscure languages, remote locations, and current demand. As a result, it is not uncommon for a translator to take 4-5 hours to arrive at a given location.

Thus, more effective patient-intake methods and systems are needed to provide instant communication between doctors and patients regardless of the languages they may speak.

### BRIEF SUMMARY

In one embodiment, a method for assisting in the communication of a medical care provider and a patient is disclosed. The method may include displaying a first display section, the first display section including a plurality of anatomical features, each anatomical feature associated with an indicia indicating the location of the anatomical feature, the anatomical feature also associated with a first name provided in a first language and a second name provided in a second language name. The method may also include displaying a second display section, the second display section including a plurality of questions relating to patient intake, where each question provided in the first language and the second language.

In another embodiment, a user interface for assisting in the communication of a medical care provider and a patient. The user interface may include a first display section, the first display section including a plurality of anatomical features, each anatomical feature associated with an indicia indicating the location of the anatomical feature, the anatomical feature also associated with a first name provided in a first language and a second name provided in a second language name. The user interface may also include a second display section, the second display section including a plurality of questions relating to patient intake, where each question provided in the first language and the second language.

These and other embodiments and aspects are described with reference to the noted Figures and the below detailed description of the preferred embodiments.

### BRIEF DESCRIPTION OF THE DRAWINGS

FIG. 1 is a diagram of an exemplary architecture for providing a user interface for language assisted patient intake;

FIG. 2 is a diagram of an exemplary screen shot for a user interface for assisting in language assisted patient intake;

FIG. 3 is another diagram of an exemplary screen shot for a user interface for assisting in language assisted patient intake;

FIG. 4 is a diagram of an exemplary display area for assisting in language assisted patient intake;

FIG. 5 is another diagram of an exemplary screen shot for a user interface for assisting in language assisted patient intake;

FIG. 6 is another diagram of an exemplary screen shot for a user interface for assisting in language assisted patient intake;

FIG. 7 is another diagram of an exemplary screen shot for a user interface for assisting in language assisted patient intake; and

FIG. 8 is another diagram of an exemplary screen shot for a user interface for assisting in language assisted patient intake.

### DETAILED DESCRIPTION

Systems and methods, generally referred to as systems, are disclosed for assisting in patient intake for patients that speak a different language from the medical care professional performing the intake. Such situations are referred to herein as language assisted patient intake. Existing technologies do not provide a comprehensive tool for assisting in language assisted patient intake. The systems described herein may solve some of these problems by providing a flexible way for providing language assistance during patient intake that allows medical professionals with little or no proficiency in a patient native language to quickly and easily obtain accurate information from the patient. Additionally, language assistance may be provided visually and may include written and/or oral language assistance.

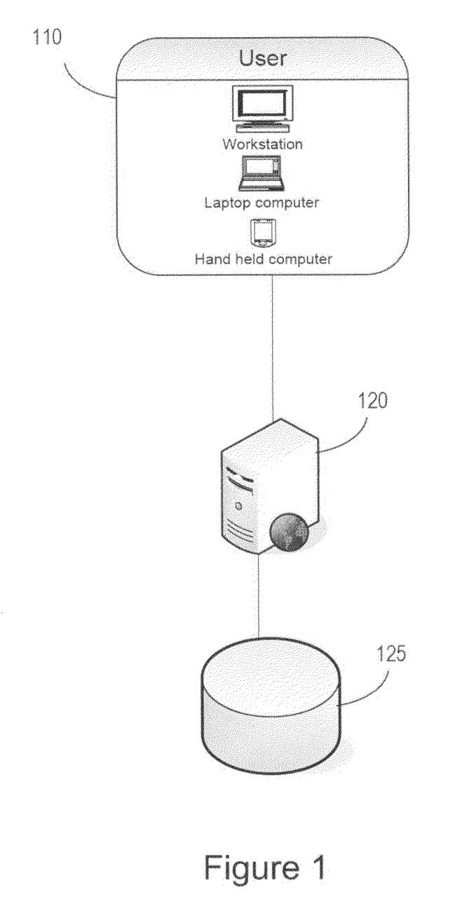

Referring now to the drawings, and initially to FIG. 1, an exemplary architecture 100 may be used for providing a user interface for language assisted patient intake. The architecture 100 may include a user client system 110, a server 120, and a content database 125. Although reference is now made to specific components of the system performing specific features, it should be apparent that such reference is exemplary, is not intended to limit the scope of the claims in any way, and that the functionalities described herein may be implemented in a virtually unlimited number of configurations.

A medical professional performing patient intake, also referred to as a front-line health provider, may operate the user client system 110. The user client system 110 may include a user interface to provide a particularly useful communication system for use in language assisted patient intake processes. The user client system 110 may include one or more display areas, described in more detail below, that assist in the communication process involved in language assisted patient intake. For example, the user interface may provide a list of informational questions in multiple languages, so that the medical professional can quickly translate the relevant question into a language the patient may understand. Typical answers may also be provided in the same languages to allow the medical profession to quickly obtain an understanding of the patient's current condition, medical history, and/or the like without the need for a translator.

The server 120 may be in communication with the user client system 110 in a variety of ways. For example, server 120 may be in communication with the user client system 110 via a communications network. The communication network may be any private or public communication network. For example, the user client system 110 may connect to the server 120 via the Internet using a standard browser application. A browser based implementation allows system features to be accessible regardless of the underlying platform of the user client system 110. For example, the user client system 110 may be a workstation computer, laptop computer, handheld computer, cell phone, mobile messaging device, or the like which may all utilize different hardware and/or software packages. Alternatively, or additionally, the user client system 110 may connect to the server 120 using a stand-alone application which may be either platform dependent or platform independent. The communications network may also include any wired or wireless networks. The communication network may include a network maintained by a medical care facility, such as a local area network maintained at a hospital.

The user interface may also be implemented in a variety of ways. As noted above, the user interface may be a browser based implementation. The client 110 of the browser based implementation may regularly contact the server 120 to provide requested language assistance information. For example, the user may request an audio file of a particular word spoken in a particular language from the server 120, which in turn may deliver the audio file to the user. Alternatively or additionally, the user interface of the client 110 may be a self contained stand alone program, such as an animated Flash™ movie using technology provided by Adobe Systems Incorporated of San Jose, Calif. The self contained program may include all of the information needed to provide language assistance, thus obviating the need for regular server contact. One of ordinary skill in the art will appreciate that virtually any other implementation may also be used.

The server 120 may receive the request for content from the user client system 110. For example, the server may be a web server that delivers a web page that includes one or more display elements for reference during a language assisted patient intake. The content may be stored in the content database 125. Other content that may also be stored in and the content database and used by the server 120. For example, audio files including an audio clip of patient intake related terms and/or phrases spoken in a particular language. The patient intake related terms and/or phrases may include a given medical term, body part, or the like. Other data may also be used.

The server 120 may also be in communication with the user profile information database 115, and may store and/or obtain information relating to the user from the database 115. User 110 information may be tracked in a variety of ways. For example, each user 110 may be represented by a user ID associated with a particular account. The account may be associated with account information such as demographic information such as age, sex, occupation, and the like about a user. The account may be associated with an account type, such as a subscription for particular services. For example, each account may have an associated list of languages which the user may access via the user interface. In such an arrangement, the user may subscribe to certain languages, and may be able to select one or more interactive displays in those languages via the user interface. Other information about the user 110 may also be maintained. Alternatively, the systems and methods described herein may be implemented without the use of user IDs.

The content server 120 may receive the request from the user 110 and communicate information indicative of the user client 110 and the advertisement properties associated with the desired content to the ad server 130. In response, the ad server 130 may select an ad to be shown in the advertisement properties of the content based on the user information. The ad server 130 may be in communication with the ad database 135, which may store information relating to advertisements. The ad server 130 may also be in communication with the user profile information database 115, and may obtain additional information relating to the user from the database 115. The ad server 130 may receive information relating to the likelihood that a particular user group may respond to an ad from the historical data analysis server 140. The ad server 130 may receive user information and ad property information from the content server 120, determine a user group for the requesting user, and select an ad for inclusion at each ad property based on the determined the user group. Optionally, the ad server 130 may also employ additional constraints that affect the delivery of a given ad, as described below.

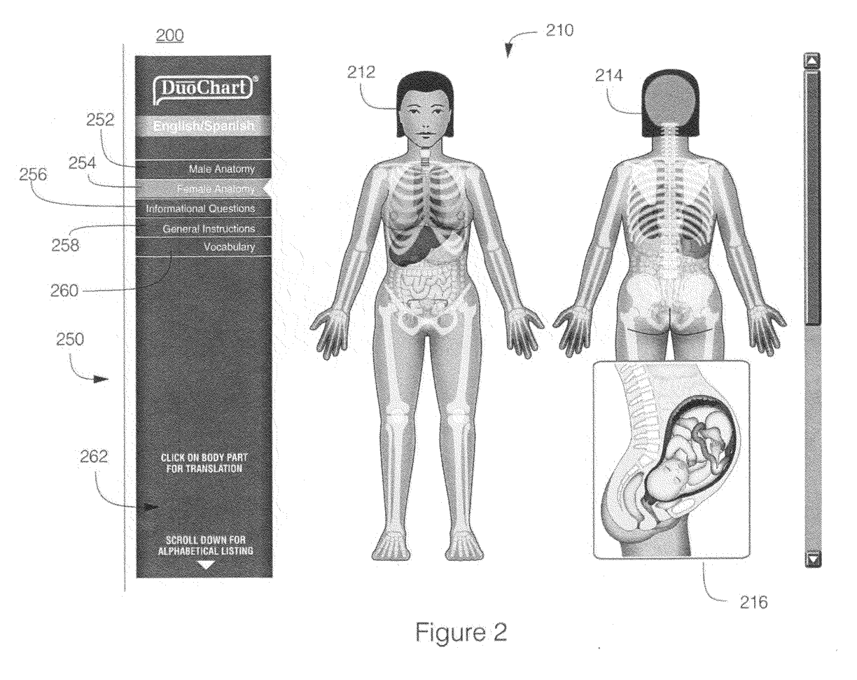

FIG. 2 is a diagram of an exemplary screen shot for a user interface for assisting in language assisted patient intake. In the example of FIG. 2, the interface 200 may include a first display area 210 and a navigation area 250. In the example of FIG. 2, user interface controls 252-262 are provided to allow the user to select various types of language assistance. Selection of a Male Anatomy control 252 may cause language assistance materials relating to the male anatomy to be displayed. Selection of the Female Anatomy control 254 may cause language assistance materials relating to the female anatomy to be displayed. Selection of an Informational Questions control 256 may cause language assistance materials for informational questions associated with the patient intake process to be displayed. Selection of a General Instructions control 258 may cause language assistance materials relating to general instructions commonly given during medical procedures, such as patient intake, to be displayed. Other controls and language assistance materials may also be used.

Selection of the navigation controls 252-260 may allow the user to navigate between various language assistance materials that are displayed in the first display area 210. Alternatively, or additionally, multiple display areas (not pictured) may also be used to display more than one type of language assistance material at the same time. Or, the navigation buttons 252-260 and language assistance materials may be provided in a single display area. Selection of the navigation controls 252-260 may cause a request to be sent from the user client 110 (FIG. 1) to the server 120 (FIG. 1) for specific language assistance material, which the server 120 (FIG. 1) may then provide to the user client 110 (FIG. 1) for displaying to the user. Or, the selection may cause locally stored language assistance materials to be displayed. Optionally, the navigation buttons 252-260 may not be used.

Optionally, a language selection control 262 may also be provided. The user may select between various language assistance options by selecting the language selection control 262. For example, the user may select which languages the language assistance materials should be presented in, such as English to Spanish. Selection of the control 262 may allow the user to select from a list of predetermined language sets, or the user may specify each of a plurality of languages in which the materials should be presented. In response, the user client 110 (FIG. 1) may cause language assistance materials in the selected language(s) to be shown. Optionally, an authorization check may be performed to ensure that the user is authorized to view materials in the selected languages assistance materials. Or, the user client 110 may include only a single set of language assistance materials, such as only English/Spanish materials, obviating the need for the language selection control 262.

When the user has requested language assistance materials relating to female anatomy by selecting the Female Anatomy control 254, one or more diagrams 212, 214, and 216 that include female anatomical features may be displayed in the first display area 210. Each diagram 212, 214, and 216 may include one or more anatomical features for which language assistance is to be provided. Each anatomical feature may appear in more than one diagram 212, 214, and 216, or each anatomical feature may only appear in a single diagram 212, 214, and 216. Multiple diagrams may be provided simultaneously, sequentially, or in any other manner. In the example shown in FIG. 2, a first diagram 212 may include anatomical features associated with or visible via the front of the body, while a second diagram 214 may include anatomical features associated with or visible via the back of the body. Additionally, specialty images may also be provided. For example, a diagram 216 may be provided to include features associated with a pregnant woman. Diagrams indicative of other conditions may also be used.

Optionally, a single diagram may be provided that includes each of the anatomical features. For example, a three dimensional image that may be rotated about one or more axes may be provided. Additionally, controls may be provided to allow a user to “zoom in” to specific regions of the body. When “zoomed in,” additional anatomical features may be displayed to the user. For example, the user may select a particular section of the body, and the diagram 212, 214, and 216 may be enlarged to show the selected area in additional detail. Or, an additional diagram 212, 214, and 216 may be displayed upon user selection of a particular body region.

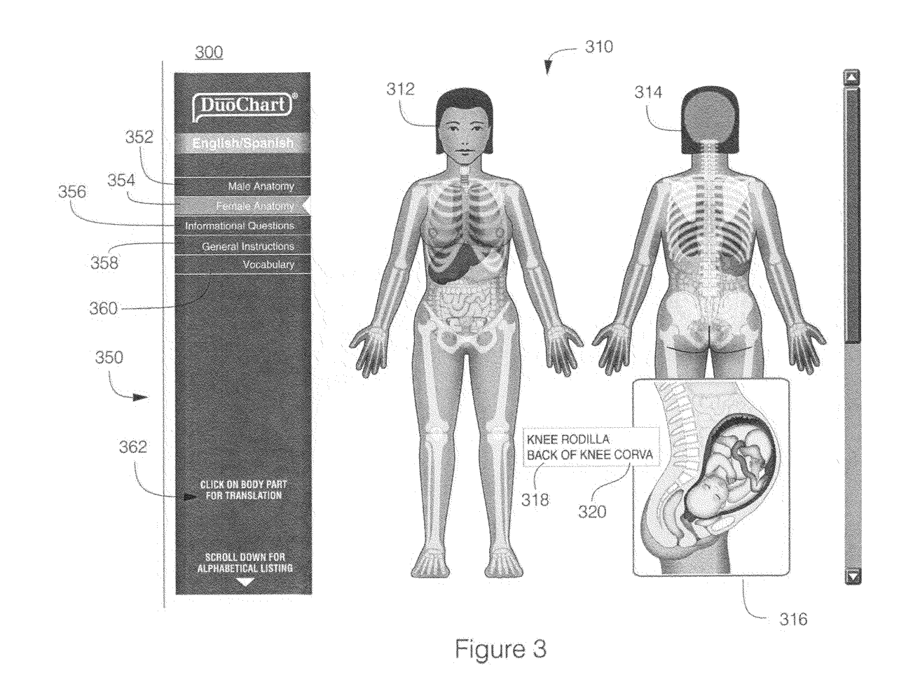

Referring also to FIG. 3, user selection of a particular anatomical feature for which language assistance materials are included may cause the associated language assistance materials to be displayed. For example, the user may place a cursor over a hotspot, such as the knee in FIG. 3, to cause language assistance materials associated with the knee to be displayed. As used herein, the term hotspot means an area of a graphical user interface the selection of which causes an action to occur. The selection may be made using any known means. In the example of FIG. 3, the language assistance materials may include a word for one or more anatomical features associated with the hotspot in both a first 318 and second language 320. Indicia (not shown) may also be used to indicate the selected hotspot. Each word 318 and 320 may be selected by the user to cause an audio clip associated with the selected word 318 and 320 to be played. Selection of either word 318 and 320 may cause both words 318 and 320 to be played. Alternatively, each word 318 and 320 may be individually selectable so that only an audio clip with the selected word is played. As a result, the user may receive pictorial, written, and/or oral language assistance.

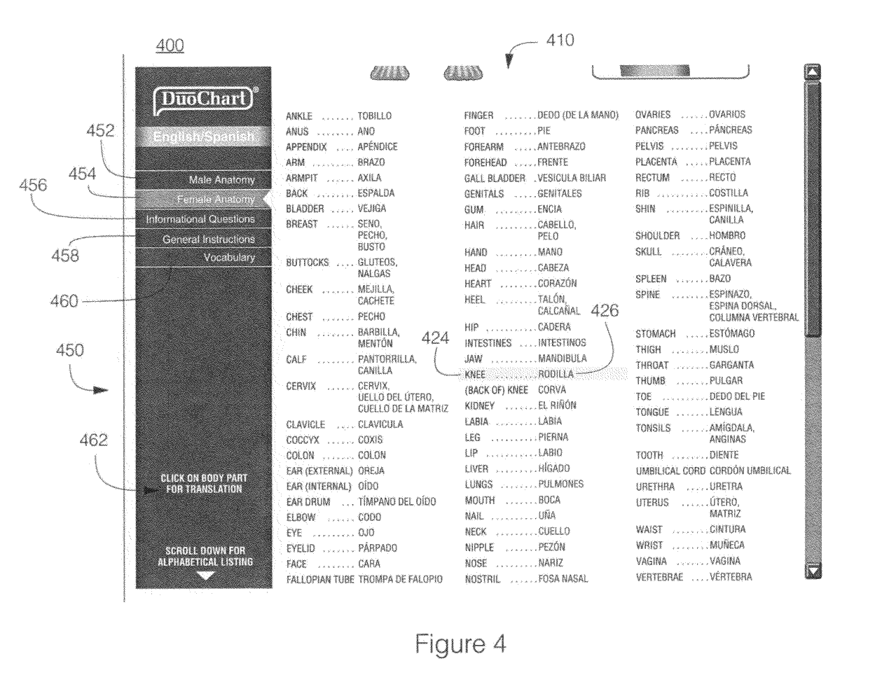

As shown in FIG. 4, a list of the anatomical features for which language assistance is provided may be provided. The list may included only those anatomical features included in the anatomical diagrams (such as 212, 214, and 216 of FIG. 2), or may include more or less features than those included in the anatomical diagram. The list may include words 424 and 426 in each of two languages for each listed anatomical feature. Similar to the words 318 and 3200 of the anatomical diagram, each word 424 and 426 may be selected by the user to cause an audio clip associated with the selected word 424 and 426 to be played. Selection of either word 424 and 426 may cause both words 424 and 426 to be played. Alternatively, each word 424 and 426 may be individually selectable so that only an audio clip with the selected word is played. The list may be sortable by the user in a variety of manners. For example, the user may alphabetize the list in any language. An exemplary list of anatomical features to be included in an anatomical diagram, in both English and Spanish, is shown in Table 1.0.

TABLE 1.0
Exemplary Anatomical Parts In English And Spanish

| | |
|---|---|
| Ankle | Tobillo |
| Anus | Ano |
| Appendix | Apéndice |
| Arm | Brazo |
| Armpit | Axila |
| Back | Espalda |
| Bladder | Vejiga |
| Breast | Seno, Pecho, Busto |
| Buttocks | Gluteos, Nalgas |
| Calf | Pantorrilla, Canilla |
| Cervix | Crevix, Uello del Útero, Cuello de la |
| | Matriz |
| Cheek | Mejilla, Cachete |
| Chest | Pecho |
| Chin | Barbilla, mentón |
| Clavicle | Clavicula |
| Coccyx | Coxis |
| Colon | Colon |
| Ear (external) | Oreja |
| Ear (internal) | Oído |
| Ear Drum | Tímpano del oído |
| Elbow | Codo |
| Eye | Ojo |
| Eyelid | Párpado |
| Face | Cara |
| Fallopian tube | Trompa de falopio |
| Finger | Dedo (de la mano) |
| Foot | Pie |
| Forearm | Antebrazo |
| Forehead | Frente |
| Gall Bladder | Vesicula Biliar |
| Glans | Glande |
| Genitals | Genitales |
| Gum | Encia |
| Hair | Cabello, pelo |
| Hand | Mano |
| Head | Cabeza |
| Heart | Corazón |
| Heel | Talón, calcañal |
| Hip | Cadera |
| Intestines | Intestinos |
| Jaw | Mandibula |
| Kidney | Riñón |
| Knee | Rodilla |
| (Back of) Knee | Corva |
| Labia | Labia |
| Leg | Pierna |
| Lip | Labio |
| Liver | Hígado |
| Lungs | Pulmones |
| Mouth | Boca |
| Nail | Uña |
| Neck | Cuello |
| Nipple | Pezón |
| Nose | Nariz |
| Nostril | Fosa Nasal |
| Ovaries | Ovarios |
| Pancreas | Páncreas |
| Pelvis | Pelvis |
| Penis | Pene |
| Placenta | Placenta |
| Rectum | Recto |
| Rib | Costilla |
| Shin | Espinillas, canilla |
| Shoulder | Hombro |
| Skull | Cráneo, calavera |
| Spine | Espinazo, espina dorsal, columna |
| | vertebral |
| Spleen | Bazo |
| Stomach | Estómago |
| Testicles | Testiculos |
| Thigh | Muslo |
| Throat | Garganta |
| Thumb | Puglar |
| Toe | Dedo del pie |
| Tongue | Lengua |
| Tonsils | Amígdala, anginas |
| Tooth | Diente |
| Umbilical Cord | Cordón umbilical |
| Urethra | Uretra |
| Uterus | Útero, matriz |
| Vagina | Vagina |
| Vertebrae | Vértebra |
| Waist | Cintura |
| Wrist | Munéca |

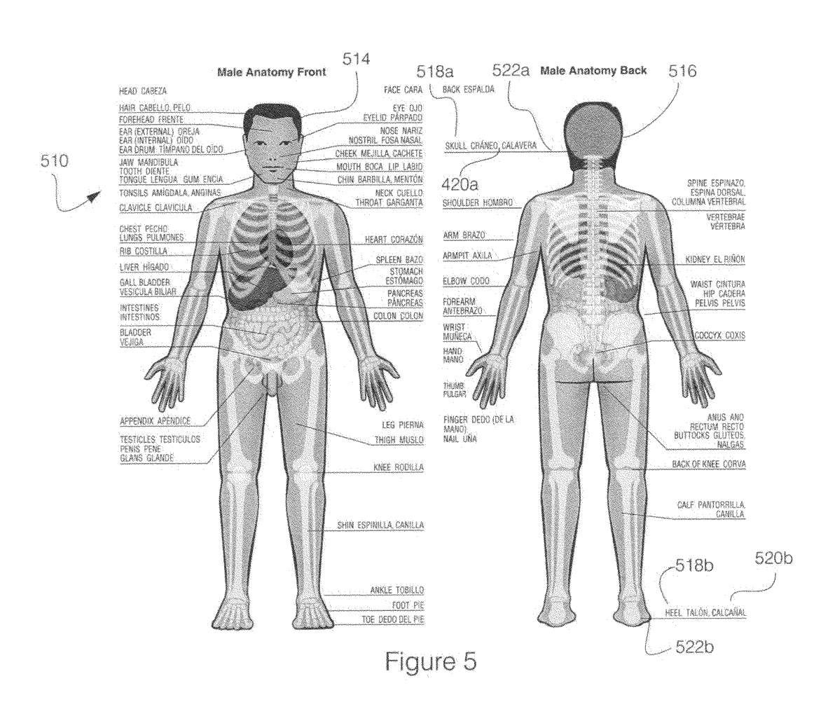

FIG. 5 is another diagram of an exemplary anatomical diagram for use in language assisted patient-intake. The diagram 510 may include one or more anatomical FIGS. 512 and 514 that illustrate features of the human anatomy. In the example of FIG. 5, the male anatomy is depicted from the front 512 and the back 514. The diagram 510 may include a plurality of anatomical features that are each associated with indicia 522a to indicate a body location associated with one or more anatomical features. Each associated anatomical feature may include multiple words 518a and 520a in language for the associated feature. The term word, as used herein, may refer to a single word or phrase, or multiple words or phrases. Each feature may be associated with a single word 518b in a first language and multiple words 520a in a second language. Each word 518a and 520a may be selected by the user to cause an audio clip associated with the selected word 518a and 520a to be played. Selection of either word 518a or 520a may cause both words 518a and 520a to be played. Alternatively, each word 518a and 520a may be individually selectable so that only an audio clip with the selected word is played. In the example of FIG. 5, each of the plurality of anatomical features may be displayed simultaneously to provide a quick reference to the plurality of spots.

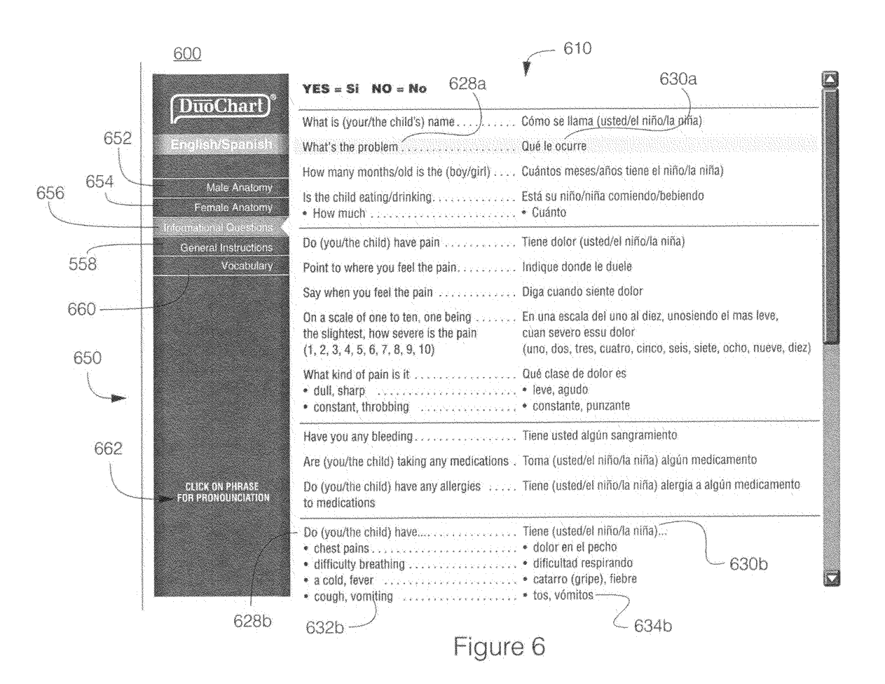

FIG. 6 is another diagram of an exemplary screen shot for a user interface for assisting in language assisted patient intake. The user interface 600 may include a set of informational questions for use during the medical procedure. An informational question may include questions relating to the patients condition, insurance related information, or any other information. The list may include informational questions in a first language 628a and a second language 630a. Or, the list may include both questions 628b and 630b and one or more potential answers 632b and 634b in multiple languages. Each informational questions 628a, 628b, 630a, and 630b (and/or answers 632b and 634b) may be selected by the user to cause an audio clip associated with the selected question 628a, 628b, 630a, and 630b to be played. Selection of either question 628a, 628b, 630a, and 630b (and/or answers 632b and 634b) may cause both words associated informational questions 628a, 628b, 630a, and 630b (and/or answers 632b and 634b) to be played. Alternatively, each question 628a, 628b, 630a, and 630b (and/or answers 632b and 634b) may be individually selectable so that only an audio clip with the selected word is played. An exemplary list of informational questions, in both English and Spanish, is shown in Table 2.0.

TABLE 2.0
Exemplary Informational Questions In English And Spanish

| | |
|---|---|
| What is [your/the child's] name | Cómo se llama [usted/el niño/la niña] |
| What's the problem | Qué le ocurre |
| How many months/old is the | Cuántos meses/años tiene el niño/la niña |
| boy/girl | |
| Is the child eating/drinking | Está su niño/niña comiendo/bebiendo |
| How much | Cuánto |
| Do [you/the child] have pain | Tiene dolor [usted/el niño/la niña] |
| Point to where you feel the pain | Indique donde le duele |
| Say when you feel the pain | Diga cuando siente dolor |
| On a scale of one to ten, one | En una escala del uno al diez, uno |
| being the slightest, how severe is | siendo el mas leve, cuan severo |
| the pain (1, 2, 3, 4, 5, 6, 7, 8, 9, | es su dolor (uno, dos, tres, cuatro, |
| 10) | cinco, seis, siete, ocho, nueve, diez) |
| What kind of pain is it | Qué clase de dolor es |
| dull, sharp | leve, agudo |
| constant, throbbing | constante, punzante |
| Are [you/the child] taking any | Toma [usted/el niño/la niña] algún |
| medications | medicamento |
| Do [you/the child] have any | Tiene [usted/el niño/la niña] alergia |
| allergies to medications | a algún medicamento |
| Do [you/the child] have | Tiene [usted/el niño/la niña] |
| chest pains | dolor en el pecho |
| difficulty breathing | dificultad respirando |
| a cold, fever | catarro (gripe), fiebre |
| cough, vomiting | tos, vómitos |
| diarrhea, constipation | diarrea, estreñimiento |
| heart disease | enfermedad del corazón |
| diabetes, asthma, allergies | diabetes, asma, alergias |
| How many births | Cuántos partos ha tenido |
| Any problems with the | Tuvo usted algún problema con el (los) |
| pregnancy(ies) | embarazo(s) |
| Have you any bleeding | Tiene usted algún sangramiento |
| Are you leaking any fluids | Tiene flujo |
| from the vagina | por su vagina |
| from the anus | por su ano |
| Can you feel the baby moving | Puede usted sentir al bebé moviéndose |
| Have you any contractions | Tiene usted contracciones |
| Have you had (do you have) any | Tuvo (Tiene) usted alguna enfermedad |
| STDs | de transmisión sexual |
| gonorrhea, syphilis, chlamydia, | gonorrea, sífilis, clamidia, herpes, SIDA |
| herpes, HIV | |
| Any family history of . . . | Hay alguien en su familia que tenga . . . |
| heart disease, diabetes | enfermedad del corazón, diabetes |
| cancer, kidney disease | cáncer, enfermedad del riñón |
| Do you smoke | Fuma usted |
| Do you drink alcohol | Bebe usted alcohol |
| Do you use drugs | Usa usted drogas |
| How much | Con qué frecuencia |
| Have [you/the child] any | Tiene [usted/el niño/la niña] algún |
| bleeding | Sangramiento |
| Are you leaking any fluid from | Le esta saliendo algun líquido de |
| your penis/anus | su pene/ano |

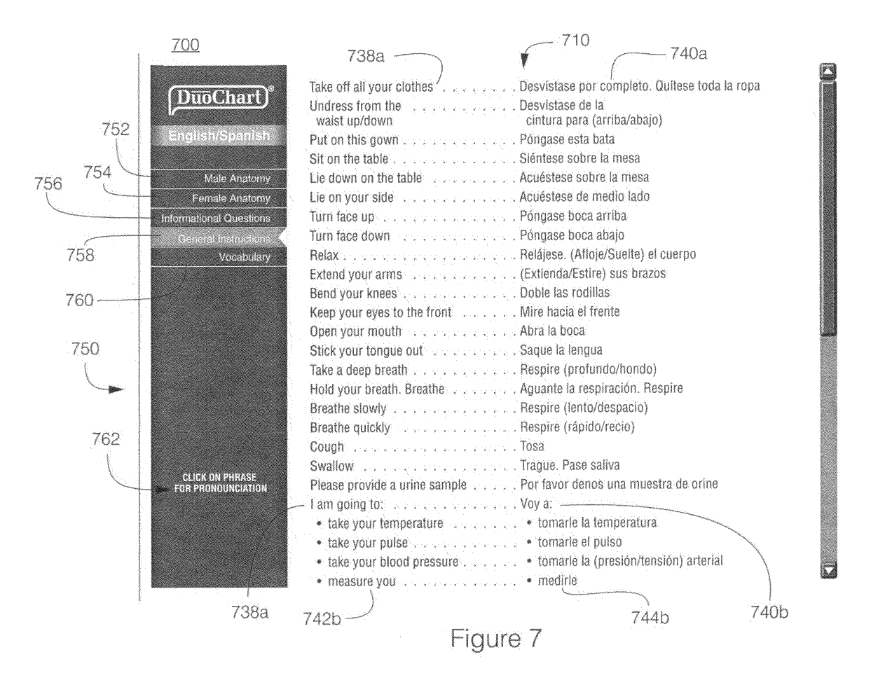

FIG. 7 is another diagram of an exemplary screen shot for a user interface for assisting in language assisted patient intake. The user interface 700 may include a set of general instructions for use during the medical procedure. A general instruction may include instructions relating to a medical procedure, such as patient intake, or any other instructional information. The list may include informational questions in a first language 736a and a second language 738a. Or, the list may include both questions 736b and 738b and one or more potential answers 740b and 742b in multiple languages. Each general instruction 736a, 736b, 738a, and 738b (and/or answers 740b and 742b) may be selected by the user to cause an audio clip associated with the selected question 736a, 736b, 738a, and 738b (and/or answers 740b and 742b) to be played. Selection of either question 736a, 736b, 738a, and 738b (and/or answers 740b and 742b) may cause both words associated informational questions 736a, 736b, 738a, and 738b (and/or answers 740b and 742b) to be played. Alternatively, each question 736a, 736b, 738a, and 738b (and/or answers 740b and 742b) may be individually selectable so that only an audio clip with the selected word is played. An exemplary list of general instructions, in both English and Spanish, is shown in Table 3.0.

TABLE 3.0
Exemplary General Questions In English And Spanish

| | |
|---|---|
| Take off all your clothes | Desvístase por completo. Quítese toda la ropa |
| Undress from the waist up/down | Desvístase de la cintura para arriba/abajo |
| Put on this gown | Póngase esta bata |
| Sit on the table | Siéntese sobre la mesa |
| Lie down on the table | Acuéstese sobre la mesa |
| Lie on your side | Acuéstese de medio lado |
| Turn face up | Póngase boca arriba |
| Turn face down | Póngase boca abajo |
| Relax | Relájese. (Afloje/Suelte) el cuerpo |
| Extend your arms | (Extienda/Estire) sus brazos |
| Bend your knees | Doble las rodillas |
| Keep your eyes to the front | Mire hacia el frente |
| Open your mouth | Abra la boca |
| Stick your tongue out | Saque la lengua |
| Take a deep breath | Respire (profundo/hondo) |
| Hold your breath. Breathe | Aguante la respiración. Respire |
| Breathe slowly | Respire (lento/despacio) |
| Breathe quickly | Respire (rápido/recio) |
| Cough | Tosa |
| Swallow | Trague. Pase saliva |
| Please provide a urine sample | Por favor denos una muestra de orine |
| When was your last menstrual period | (Cuándo/En qué fecha) tuvo usted su |
| | última regal |
| What age did you have your first period | A qué edad tuvo usted su primera regal |
| How many days are your periods | Cuántos días duran sus reglas |
| How many days between your periods | Cuántos días hay entre sus reglas |
| How many pregnancies | Cuántos embarazos ha tenido |
| How many births | Cuántos partos |
| Any problems with the pregnancy(ies) | Tuvo usted algún problema con el (los) |
| | embarazo(s) |
| I am going to: | Voy a: |
| take your temperature | tomarle la temperature |
| take your pulse | tomarle el pulso |
| take your blood pressure | tomarle la (presión/tensión) arterial |
| weigh you | pesarle |
| measure you | medirle |
| take a blood sample | sacarle sangre |
| a sputum sample | tomarle una muestra de (esputo/saliva) |
| take some x-rays | sacarle (unos rayos |
| | equis/radiografías/placas) |
| give you an injection | ponerle una inyección |
| You need: | Usted necesita: |
| to be hospitalized | hospitalizarse, ir al hospital |
| to be in bed | estar en cama |
| to see a specialist | consultar a un especialista |
| have an operation | una operación |
| You have an infection | Usted tiene una infección |
| We'll give you an antibiotic | Le daremos un antibiótico |

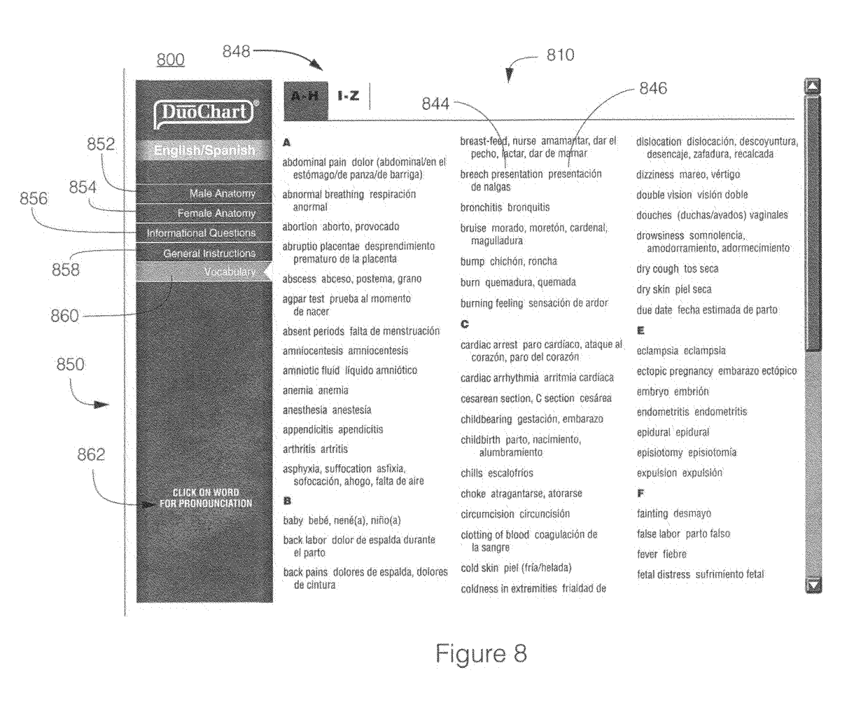

FIG. 8 is another diagram of an exemplary screen shot for a user interface for assisting in language assisted patient intake. The user interface 800 may include a set of vocabulary items, such as words or phrases, related to various medical procedures. A vocabulary item may include words or phrases relating to medical conditions, symptoms, and the like or any other information. The list may include vocabulary items in a first language 7844 and a second language 846. Each vocabulary item 844 and 846 may be selected by the user to cause an audio clip associated with the selected vocabulary item 844 and 846 to be played. Selection of either vocabulary item 844 and 846 may cause both words associated vocabulary item 844 and 846 to be played. Alternatively, each vocabulary item 844 and 846 may be individually selectable so that only an audio clip with the selected word is played. An exemplary list of general instructions, in both English and Spanish, is shown in Table 4.0.

TABLE 4.0
Exemplary Vocabulary In English And Spanish

| | |
|---|---|
| abdominal pain | dolor (abdominal/en el estómago/de |
| | panza/de barriga) |
| abnormal breathing | respiración anormal |
| abcess | abceso, postema, grano |
| abortion | aborto, provocado |
| abruptio placentae | Desprendimiento prematuro de la placenta |
| agpar test | prueba al momento de nacer |
| absent periods | falta de menstruación |
| amniocentesis | Amniocentesis |
| amniotic fluid | líquido amniótico |
| anemia | anemia |
| anesthesia | Anesthesia |
| appendicitis | apendicitis |
| arthritis | artritis |
| asphyxia, suffocation | asfixia, |
| | sofocación, ahogo, falta de aire |
| Baby | bebé, nené(a), niño(a) |
| Back labor | dolor de espalda durante el parto |
| Back pains | Dolores de espalda, Dolores de cintura |
| bag of water | bolsa de agua |
| birth defect | Defecto de nacimiento |
| bleeding | Sangrar, desangramiento, hemorragia |
| bleeding between periods | Sangrar entre (períodos/reglas) |
| blindness | ceguera |
| blister | ampolla vejiga |
| blood clot | coágulo de sangre |
| blood in sputum | sangre en (el esputo/la saliva) |
| blurred vision | vista (nublada/empañada) |
| blood in the urine | sangre en la orina |
| blood in the stool | sangre en (el excremento/las heces |
| | fecales) |
| blood pressure: | presión arterial: |
| low-, high- | baja, alta |
| bone | Hueso |
| bone fracture | (fractura/quebradura) de hueso |
| bottle feed | dar biberón, alimentar con biberón |
| bowel movement | obrar, defecar, excretar |
| burp | Eructar |
| brain stroke | (derrame/embolia) cerebral |
| breast engorgement | hinchazón de senos |
| breast milk | leche maternal |
| breast pump | bomba para senos |
| breast-feed, nurse | amamantar, dar el pecho, lactar, dar de |
| | mamar |
| breech presentation | presentación de nalgas |
| bronchitis | Bronquitis |
| bruise | morado, moretón, cardenal, magulladura |
| bump | chichón, roncha |
| burn | quemadura, quemada |
| burning feeling | sensación de ardor |
| cesarean section, C section | Cesarean |
| childbearing | gestación, embarazo |
| childbirth | parto, nacimiento, alumbramiento |
| circumcision | Circumcision |
| colostrum | Calostro |
| conception | Concepción |
| (to) conceive | Concebir |
| contractions | Contracciones |
| cravings | Antojos |
| (to) deliver, give birth | dar a luz, tener el bebé, parir |
| delivery room | sala de parto |
| diaper rash | salpullido de pañal, pañalitis, dermatitis |
| | del pañal, rozadura, escaldadura |
| diaper-urine test | prueba de orina |
| dilatation of the cervix | dilatación de la (cervix/matriz) |
| douches | (duchas/avados) vaginales |
| due date | fecha estimada de parto |
| eclampsia | Eclampsia |
| ectopic pregnancy | embarazo ectópico |
| embryo | Embrión |
| endometritis | Endometritis |
| epidural | Epidural |
| episiotomy | episiotomía |
| irregular periods | (menstruación/regla/período) irregular |
| labor | parto, trabajo de parto |
| labor pains | dolores de parto |
| labor positions | posiciones durante el parto |
| lactation | Lactancia |
| maternity | Maternidad |
| mastitis, breast infection | mastitis, infección de los senos |
| meconium | Meconio |
| menstrual flow | flujo menstrual |
| menstrual pains | dolores de la menstruación, cólicos |
| | menstruales, dolor de regal |
| midwife | partera, comadrona |
| milk | Leche |
| (the) milk “comes in” | la leche baja |
| milk glands | glándulas mamarias |
| milk supply | cantidad de leche |
| miscarriage | aborto (espontáneo/natural/no deseado) |
| mucous plug | tapón mucoso |
| natural childbirth | parto natural |
| nausea | Nausea |
| new mother | madre primeriza, nulípara |
| newborn | recién nacido |
| obstetrician (OB) | Obstetra |
| obstetrics | Obstetrician |
| paternity | Paternidad |
| perineum | Perineo |
| period | regla, menstruación, período |
| placenta | Placenta |
| placenta previa | placenta previa |
| postpartum | Postparto |
| postpartum depression | Depresión postnatal |
| preeclampsia | Preeclampsia |
| pregnancy | Embarazo |
| pregnancy and delivery | embarazo y parto |
| pregnancy test | prueba de embarazo |
| prelabor | antes del parto |
| premature | prematuro, antes de tiempo |
| prenatal | Prenatal |
| (to be) pregnant | estar embarazada |
| prenatal care | (cuidado/atención) prenatal |
| prenatal vitamins | vitaminas prenatales |
| preterm labor | parto antes de tiempo |
| push downwards | empujar, pujar |
| recovery | Recuperación |
| Rh factor | factor Rh |
| rupture of membranes/ | ruptura de la bolsa de aguas |
| bag of waters | |
| sanitary napkins | toallas (sanitarias/higiénicas), cinturón |
| | sanitario |
| sexual relations | relaciones sexuales |
| sore nipples | pezones adoloridos |
| stages of childbirth | etapas del parto |
| sterilize | Esterilizar |
| stillbirth | nacimiento de bebé muerto |
| stitches | puntos, puntadas |
| (to) suck | chupar, mamar |
| tampons | Tampons |
| tear | desgarre, desgarramiento |
| twins | mellizos, mellizas |
| urine sample | muestra de orina |
| urinalysis | exámen de orina |
| vaginal bleeding | Sangramiento vaginal |
| vaginal discharge | (flujo/desecho) vaginal |
| weight | Peso |
| weight at birth | peso al nacer |

It is therefore intended that the foregoing detailed description be regarded as illustrative rather than limiting, and that it be understood that it is the following claims, including all equivalents, that are intended to define the spirit and scope of this invention.

1. A method for assisting in the communication of a medical care provider and a patient, the method comprising:
displaying a first display section, the first display section including a plurality of anatomical features, each anatomical feature associated with an indicia indicating the location of the anatomical feature, the anatomical feature also associated with a first name provided in a first language and a second name provided in a second language name; and
displaying a second display section, the second display section including a plurality of questions relating to patient intake, where each question provided in the first language and the second language.

2. The method of claim 1, where the plurality anatomical features are displayed substantially simultaneously.

3. The method of claim 1, further comprising displaying the first and second display sections via a computer.

4. The method of claim 1, further comprising displaying a third display section, the third display section including a plurality of instructions relating to at least one medical procedure, where each instruction is provided in the first language and the second language.

5. The method of claim 4, further comprising displaying a third display section, the third display section including a plurality of vocabulary items relating to at least one medical condition, where each vocabulary item is provided in the first language and the second language

6. The method of claim 3, further comprising providing navigation controls operative to allow the user to initiate display of either the first display section or second display section.

7. The method of claim 3, further comprising providing language selection controls operative to allow the user to select either the first language or the second language.

8. The method of claim 7, further comprising comparing the user selected language against a set of allowed languages associated with the user.

9. The method of claim 3, comprising providing an audio playback control operable to allow the user to initiate playback of an audio clip of either the first name or the second name.

10. The method of claim 3, comprising providing an audio playback control operable to allow the user to initiate playback of an audio clip of both the first name and the second name.

11. A user interface for assisting in the communication of a medical care provider and a patient, the user interface comprising:
a first display section, the first display section including a plurality of anatomical features, each anatomical feature associated with an indicia indicating the location of the anatomical feature, the anatomical feature also associated with a first name provided in a first language and a second name provided in a second language name; and
a second display section, the second display section including a plurality of questions relating to patient intake, where each question provided in the first language and the second language.

12. The user interface of 11, further comprising displaying the first and second display sections via a computer.

13. The user interface of claim 11, further comprising displaying a third display section, the third display section including a plurality of instructions relating to at least one medical procedure, where each instruction is provided in the first language and the second language.

14. The method of claim 13, further comprising displaying a fourth display section, the fourth display section including a plurality of vocabulary items relating to at least one medical condition, where each vocabulary item is provided in the first language and the second language.

15. The method of claim 12, further comprising providing navigation controls operative to allow the user to initiate display of either the first display section or second display section.

16. The method of claim 12, further comprising providing language selection controls operative to allow the user to select either the first language or the second language.

17. The method of claim 16, further comprising comparing the user selected language against a set of allowed languages associated with the user.

18. The method of claim 12, comprising providing an audio playback control operable to allow the user to initiate playback of an audio clip of either the first name or the second name.

19. The method of claim 12, comprising providing an audio playback control operable to allow the user to initiate playback of an audio clip of both the first name and the second name.

20. A system for providing language assistance to the user, the system comprising:
a language assistance material database operable to store language assistance materials;
a server in communication with the language assistance material database and operable to retrieve language assistance materials from the language assistance material; and
a client in communication with the server and operable to request language assistance materials from the server, receive language materials from the server, and display the received language materials to a user,
where the client includes a user interface including:
a first display section including a plurality of anatomical features, each anatomical feature associated with an indicia indicating the location of the anatomical feature, the anatomical feature also associated with a first name provided in a first language and a second name provided in a second language name,
a second display section including a plurality of questions relating to patient intake, where each question provided in the first language and the second language,
a third display section including a plurality of vocabulary items relating to at least one medical condition, where each vocabulary item is provided in the first language and the second language,
a fourth display section including a plurality of vocabulary items relating to at least one medical condition, where each vocabulary item is provided in the first language and the second language, and
navigation controls operative to allow the user to initiate display of either the first display section, the second display section, the third display section, or the fourth display section.
